(19) United States
(12) Patent Application Publication
(10) Pub. No.: US 2012/0301205 A1
(43) Pub. Date: Nov. 29, 2012

(54) "Y" shaped writing implement with a mechanical eraser that is located at the writing end of the writing instrument placing the eraser close to the paper and easy to access

(76) Inventor: Steve Joseph Pyle, Silverdale, WA (US)

(21) Appl. No.: 13/481,551

(22) Filed: May 25, 2012

Related U.S. Application Data
(60) Provisional application No. 61/489,968, filed on May 25, 2011.

(51) Int. Cl. B43K 29/02; B43K 25/00

(52) U.S. Cl. 401/52; 15/428

(57) ABSTRACT

A writing implement with a mechanical eraser cartridge, having a forward-positioned eraser and method. The eraser and eraser cartridge runs practically the full length of the writing implement before splitting and deviating at a slight angle outward, near the writing end of the implement, slightly above the position, where upon, the writing end of the implement is held. The eraser is mechanically advanced through the eraser cartridge by the user, and exits the eraser cartridge down at the writing end of the implement.

This application claims priority benefit of provisional application No. 61/489,968 of May 25, 2011

### BACKGROUND OF THE INVENTION

Hand-held writing implements of today, such as the wooden pencil, the mechanical pencil and all varieties of ink based writing implements are commonly known for containing an end designated for writing, and an end designated for erasing—both of which are located on opposite extremes of one another. These current models require their users to flip the writing implements 180° to erase mistakes and then to flip back 180° to commence writing again. This act of inverting the writing implement, in order to correct mistakes, interrupts the flow of the user's writing and is time-consuming, and in some cases, can be challenging to those with limited dexterity. Additionally, due to the physical limitations in size and length of the typical writing implement, erasers that are affixed to the opposite end of these implements have historically been limited in length, thus, often wear out quickly, consequently, writing implements are often discarded before they have exhausted the capability to write. Many writing implements offer the opportunity to replace exhausted erasers, but can, at times be a burden, since the replacement erasers are also limited in size and continue to require frequent replacements.

A need exists for an implement that contains a longer eraser that is positioned proximate the writing end, providing for a longer user, life-span, added comfort, and ease of erasing without the requirement of inverting the implement in order to correct mistakes. The present invention satisfies these needs and provides other related advantages.

This application claims priority benefit of Provisional Application No.: 61/489,968

Filling Date for Provision Application: May 25, 2011

Primary Inventro Filing: Steve J. Pyle
10501 Warren RD NW
Silverdale Wash., 98383

Relevance to Current Utility Patent Filing: Prior Art has been altered and Descriptions and Invention Details have been changed to reflect adequate filling needs for current Utility Patent.

### DETAILED DESCRIPTION OF THE INVENTION

In FIG. 1—this illustration shows the writing and erasing implement as one single unit. The term Y-Writing Implement as used herein, is intended to describe both the writing and erasing implement embodiment as a single unit. The single unit; Y-Writing Implement is a fabricated, protective outter housing embodiment that may contain both an elongated eraser 2, that is mechanically advanced, and either an inner lead or an inner ink dispensing device 6. In reference to the item number six (6); the writing end “cap” portion only, of the lead (or ink) despensing device is featured as a visual to demonstrate the location of the writing end, (and is not intended to imply any other relationship or purpose to either the Y-Writing Implement or the lead (or ink) despensing device). Both the eraser and the lead (or ink) dispensing device are separated by an inner wall 5. The eraser container 1 is an integral part of the Y-Writing Implement and runs near to the full length of the implement—for the purpose of carrying a long eraser 2. The eraser container portion of the Y-Writing Implement 1 deviates (departs) at a slight angle away from the body near the writing end of the implement 3, and ends at a point 4 that is uniquely and recognizably closer to the area of contact between a writing surface, and the lead (or ink) dispensing device.

FIG. 2—illustrates the possibilities of location, angle and length in relation to the “Y” region on the Y-Writing Implement. At the point at which the eraser and eraser container deviates 3 away from the writing implement, (near the writing “end”, at the point where the “Y” forks), may be positioned closer or further away from the writing end, and the angle at which the eraser container devitates may be more, or may be less accentuated then depicted, and may deviate and angle away from the mated unit 7, further or less than depicted—but should be no less than 10 degrees and no greater than 40 degrees.
1. The angle at which the eraser and eraser container deviates 7 away from the main body of the Y-Writing Implement (near the writing end, at the point where the “Y” forks) should be no less than 10 degrees and no greater than 40 degrees 7; 20°≦7≦40°.
2. The length 6 of the eraser container between the point at which it begins to angle outward from the main body and the point at which the erasers exits the container, should be no shorter than 0.5 inch and no longer than: 1.5 inches; 0.5″≦6≦1.5″.
3. The distance 8 between the writting end (where by the lead (or ink) despensing device's end cap mounts to the writing container) and center of the inner archway 9 between the eraser container and the writing container, should be no closer than 0.25 inches and no further than: 1.75 inches; 0.25″≦8≦1.75″.

FIG. 3—illustrates the possibility for an eraser advance and retract “mechanism. FIG. 3a shows an enlarge view of the complete mechanism and inner eraser container wall. FIG. 3b shows an enlarged, enclosed view of the complete mechanism alone. The eraser 2 may be, (but is not limited to being) advanced and retracted by means of a mechanical mechanism that is comprised of a button 10 that is connected to a Ball and Plunger mechanism 11, that with forward or backward finger pressure, rolls and engages at incrementally placed divots (or dimples), located on the inner wall of the erasing container 12. Item number 13 illustrates a possible cylindrical shaped retainer which may be used to grasp and retain the eraser firmly mounted to the advance and retracting mechanism.

Materials; the Y-Writing Implement, as a whole, may be made of various different materials such as metals, wood, plastics, composites, etc. It may come in various thicknesses, densities and shapes such as round, square, oval, square with rounded edges and/or any combination of each—relative to common use.

Construction/Manufacturing; the Y-Writing Implement may be constructed, but is not limited to, construction by way of injection molding, or CNC machined, or die cut and machined, or any possible combination of each of the aforementioned construction procedures.

### BRIEF DESCRIPTION OF THE DRAWINGS

FIG. 1—is a front view of the combined implement illustrating the positioning and relevance of the eraser cartridge and eraser positioned as an integral component to the writing implement.

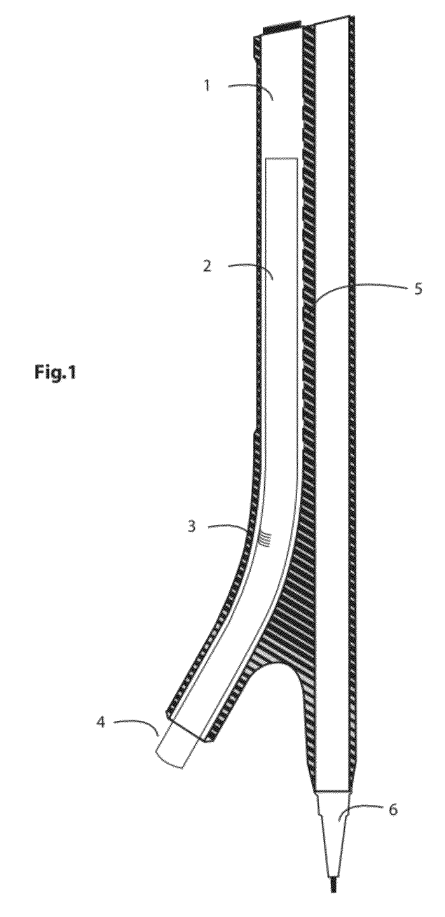

FIG. 2—illustrates the potential location, potential angles and potential length of the eraser container at the point at which it deviates from the main joined body of the writing implement.

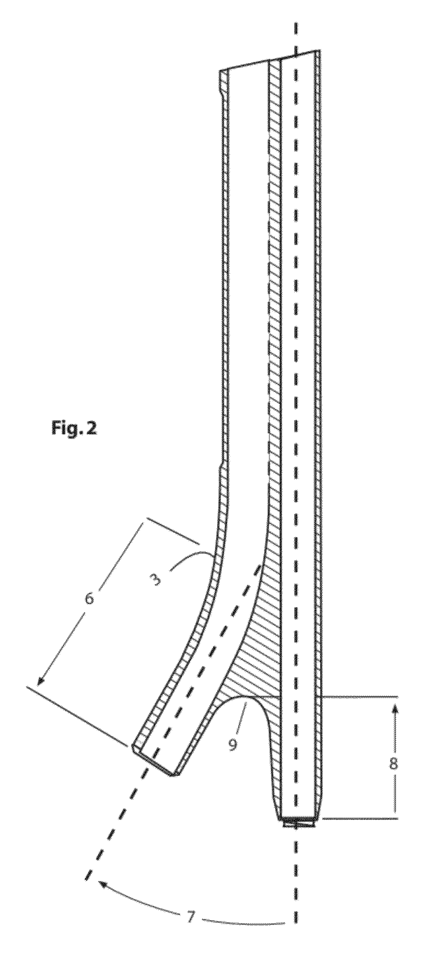

FIG. 3—illustrates the posibility of using a Ball and Plunger, type mechanism and button/slide to advance and retract the eraser within the eraser container.

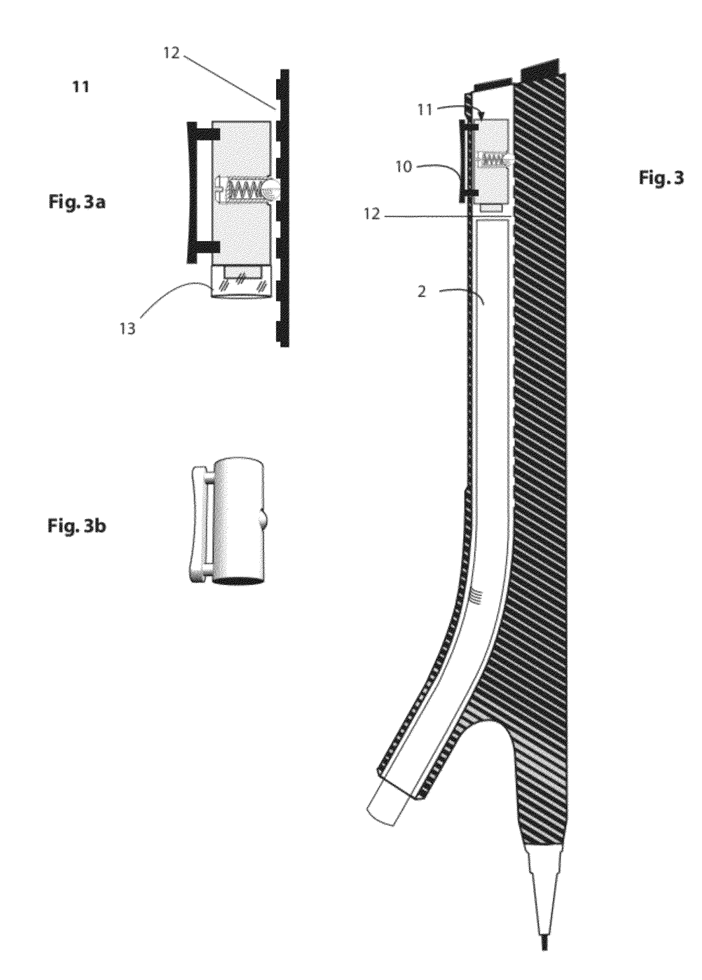

### SUMMARY OF THE INVENTION

For sake of description purposes the new implement disclosed in this application will be refered to as the “Y-Writing Implement”. Note: this name does not constitute the final trade, brand or product name of this new invention, nor does it refer to the specific nature of the implement; that of being exclusively assigned to a lead bearing “pencil” implement—as the Y-Writing Implement will work equally as well for other erasable devices such as ink pens that carry erasable ink.

The new implement is both a writing device and an erasing device, both combined into a single contained unit that provides an improved writing and erasing experience, by way of the unique combination that places the eraser, at the writing end of a lead (or ink) Y-Writing Implement, whereby the eraser container splits away from the writing container to make room for the fingers, near the writing end, of the Y-Writing Implement.

The primary purpose of the new Y-Writing Implement, split-end-embodiment, is to alleviate the need to flip the pencil or pen, to the opposite end, to correct a mistake. This is accomplished in the Y-Writing Implement's design by placing the eraser down by the writing end to make it practically effortless to switch from writing to erasing and back to writing, the user can simply rotate, or twist, the wrist, to quickly erase a mistake.

Additionally, the eraser container allows for a much longer eraser, such as an eraser that can extend the full-length of Y-Writing Implement, making the eraser considerably longer than previous wooden, and mechanical pencils, and erasable ink pens, of present and past—thus increasing the eraser's usable life-span.

The Y-Writing Implement split-end design presents additional grip or finger positioning opportunities that are not present with today's conventional writing instruments. These new positions can provide added comfort positions and control for the user.

I claim:

1. A writing implement container, comprising:
a. a body with two compartments, separated by an interior dividing wall, where;
b. one compartment, herein referred to as, the writing compartment, is designated to contain a lead or ink writing dispenser unit, and the means for attaching said dispenser unit,
c. a second compartment, herein referred to as the eraser container, is designated to contain an eraser, with means to contain a finger operated mechanism used to mechanically advance and retract said raser, whereby,
e. the said eraser exits, the eraser container, for use, adjacent to the said writing container, down at the writing end of the said writing implement, and whereby
f. the said eraser container, splits away, at a slight angle, from said writing container, near the writing end, just above a given position whereby the user's fingers grip the said writing container.

2. A writing implement container, comprising:
a. a body with two compartments, separated by an interior dividing wall, where;
b. one compartment, a writing compartment, is for containing a lead or ink writing dispenser unit, and is straight, and is no longer than 8 inches in length, and is mated with,
c. a second compartment, an eraser compartment, designated for containing an eraser that is mechanically advanced, whereby the container is no longer than 8 inches in length and splits from adjoining said writing compartment, near the writing end, angling outward, just above the writing grip-postition near the writing end, whereby,
d. the eraser exits for use, proximate the writing-end-point used for the task of writing.

3. A writing implement container, comprising:
a. a body with two compartments, separated by an interior dividing wall, where;
b. one compartment is designated for containing a lead or ink writing dispenser unit and the other is designated for containing an eraser and mechanical eraser advance-and-retract mechanism, whereby said advance-and-retract mechanism is attached by an outer button that slides up and down a thin opening that runs the length of the eraser container and advances the eraser towards an exit, whereby at point of exit, the said eraser becomes exposed, for use, near the writing end of the writing implement, whereby,
c. the said eraser container deviates away from the writing container, at a slight angle, and splits just before the position designated for the user's fingers whereby placed while gripping the writing instrument to perform the task of writing.
